(19) United States
(12) Patent Application Publication
(10) Pub. No.: US 2005/0235710 A1
(43) Pub. Date: Oct. 27, 2005

(54) Branched wire lock

(76) Inventor: Renny Tse-Haw Ling, Chung-Ho City (TW)

Correspondence Address: NORTH AMERICA INTELLECTUAL PROPERTY CORPORATION, P.O. BOX 506, MERRIFIELD, VA, 22116, US

(21) Appl. No.: 10/829,338

(22) Filed: Apr. 22, 2004

(51) Int. Cl. E05B 73/00

(52) U.S. Cl. 70/58; 70/30

(57) ABSTRACT

A branched wire lock includes a trunk wire and a branch wire. The trunk wire has one end fastening to a coupling section to couple on an anchor object or a theft-deterrent object. The branch wire has a distal end fastening to a lock head to couple on a theft-deterrent object. It can overcome the problems of insufficient anchor objects and poor locations occurred to a conventional single cable lock. And it may be adapted to display site or actual facility conditions to adjust the connection method to meet theft-deterrent requirements when merchandises are displayed.

### BACKGROUND OF THE INVENTION

1. Field of the Invention

The present invention relates to a lock and particularly to a composite lock with adjustable connection to suit actual conditions of display sites or facilities.

2. Description of the Prior Art

Nowadays many shops and stores display merchandises in an open rack fashion. While consumers can freely select and fetch the goods desired, it also increases the risk of shoplifting. Hence various types of theft-deterrent measures and means have been developed to address this concern.

Take notebook computers for instance. In order to prevent shoplifting, the computer case now has a standard jack to couple with a lock. ROC patent publication Nos. 435563 and 467185 disclose the locks that may be coupled with the notebook computers. Such type of lock can be latched on a preformed jack on the notebook computer, and the lock is fastened to a steel cable for coupling on an anchor object such as a pillar, an annular ring or a hook to prevent shoplifting.

However, one of the problems often occurred to vendors is that the sales or display site not always totally meet requirements. And not every display goods has an anchor object nearby for coupling, and not every location where the anchor object is stationed is suitable for coupling (may be too far away or difficult to do coupling operation).

As a result, vendors have to add extra anchor objects on the display rack for this purpose. Or a plurality of displaying goods have to be coupled on the same anchor object and result in lengthy steel cables, and the display racks become untidy. This problem causes a lot troubles that remain to be resolved to date.

### SUMMARY OF THE INVENTION

Therefore the primary object of the invention is to resolve the problem related to displaying a large number of merchandises that does not have sufficient anchor objects or have poorly situated anchor objects that causes locking difficult or impossible.

In view of the aforesaid disadvantages, the present invention aims at providing a branched wire lock that includes a connection wire and a plurality of lock heads. The connection wire has a trunk wire and branch wires connecting to the trunk wire. The trunk wire has a coupling section at one end to fasten to an anchor object. The lock heads are fastened respectively to the distal ends of the branch wires.

By means of the present invention, the trunk wire and the branch wires may be coupled and fastened to the anchor object or theft-deterrent goods. And they are adjustable according to the display sites or the quantity and location of the anchor objects on the display racks.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic view of a first embodiment according to the invention.

FIG. 2 is a schematic view of a second embodiment according to the invention.

FIG. 3 is a schematic view of a third embodiment according to the invention.

FIG. 4 is a schematic view of a fourth embodiment according to the invention.

FIG. 5 is a schematic view of a fifth embodiment according to the invention.

FIG. 6 is a schematic view of a sixth embodiment according to the invention.

FIG. 7 is a schematic view of a seventh embodiment according to the invention.

FIG. 8 is a schematic view of an eight embodiment according to the invention.

FIG. 9 is a schematic view of a ninth embodiment according to the invention.

FIG. 10 is a schematic view of a tenth embodiment according to the invention.

FIG. 11 is a schematic view of an eleventh embodiment according to the invention.

### DESCRIPTION OF THE PREFERRED EMBODIMENTS

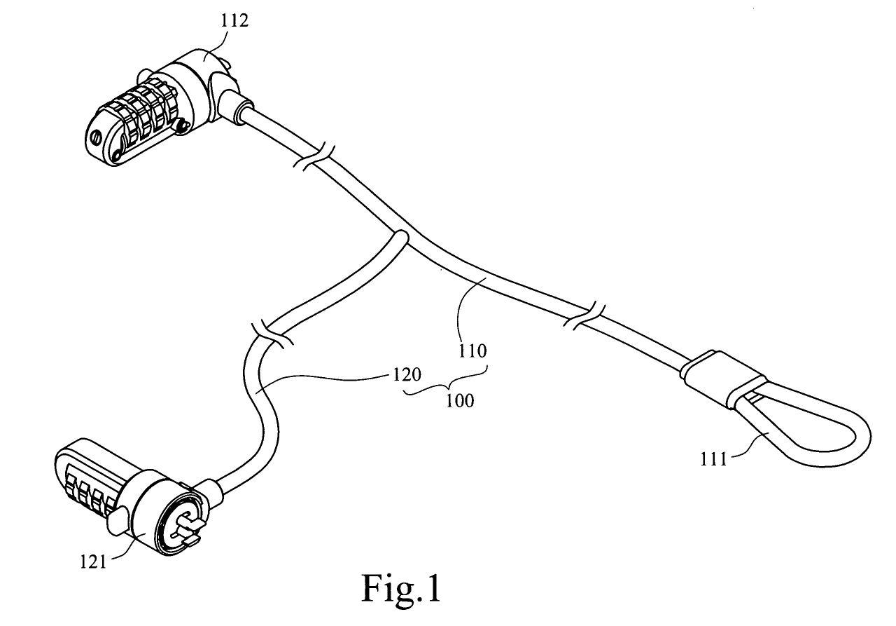

Refer to FIG. 1 for a first embodiment of the invention. The branched wire lock includes a connection wire 100 and lock heads 112 and 121.

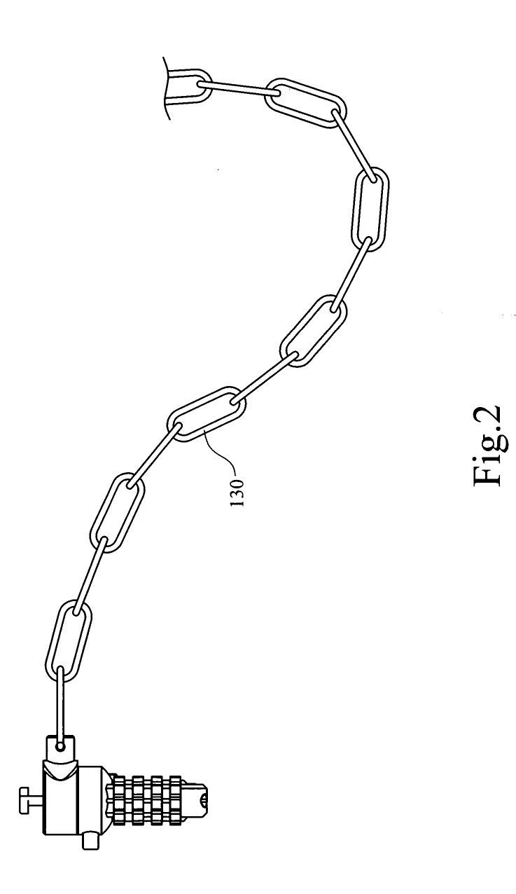

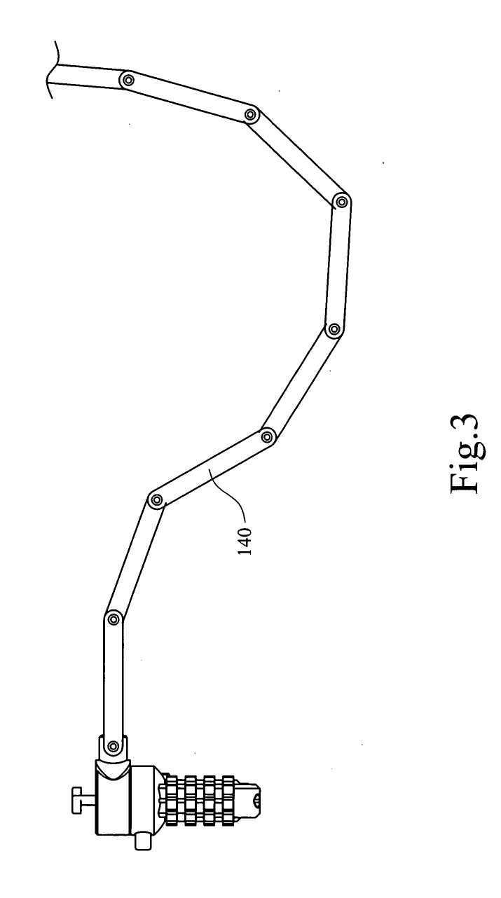

The connection wire 100 may be made of a flexible wire. It includes a trunk wire 110 and a branch wire 120 connecting to the trunk wire 110. Aside from the flexible wire, the connection wire 100 may also consist of coupling units such as a chain 130 shown in FIG. 2, or linkage bars 140 shown in FIG. 3.

The trunk wire 110 has one distal end forming a coupling section 111 which is directly formed by winding and fastening the distal end of the wire to become an annular ring. In practice, the distal end of the wire may be coupled with an independent annular ring. The trunk wire 110 has another end fastening to a lock head 112. The lock head is a jack lock (i.e. a general computer lock) to latch a jack on any theft-deterrent articles, such as electronic devices, appliances, and the like.

The branch wire 120 is connected to the trunk wire 110. It has another end fastening to another lock head 121 for latching on another theft-deterrent article.

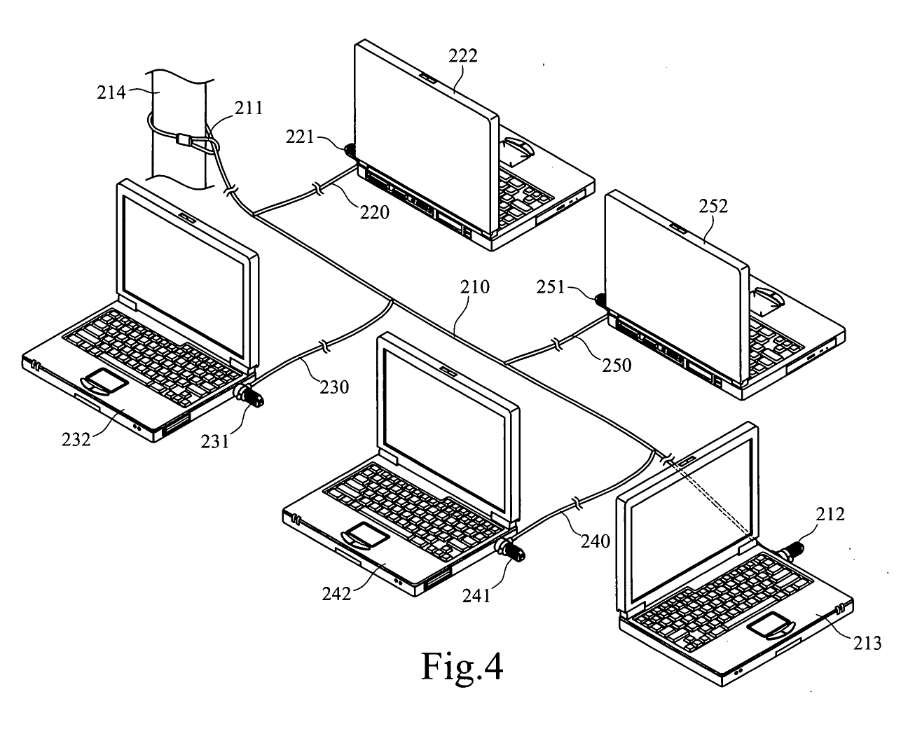

Referring to FIG. 4, when in use, the trunk wire 210 may be connected to a plurality of branch wires 220, 230, 240 and 250 in different radial locations. The trunk wire may have both ends fastening to anchor objects. In practice, it may also have one end fastening to a lock head 212 to latch on a notebook computer 213 and another end fastening to a coupling section 211 (annular ring) to fasten to an annular article or hook of an anchor object such as a pillar 214 by winding, coupling or tying as shown in the drawing. Then the lock heads 221, 231, 241 and 251 of the branch wires 220, 230, 240 and 250 may be latched on any theft-deterrent articles, such as notebook computers 222, 232, 242 and 252 shown in the drawing. It is obvious that the invention can use a plurality of branch wires to lock theft-deterrent articles. It is not achievable by the conventional techniques that use one cable lock to couple with one article. In addition, multiple branch wires may also be interlocked with the theft-deterrent articles so that a great number of articles are connected in series to make pilfering more difficult.

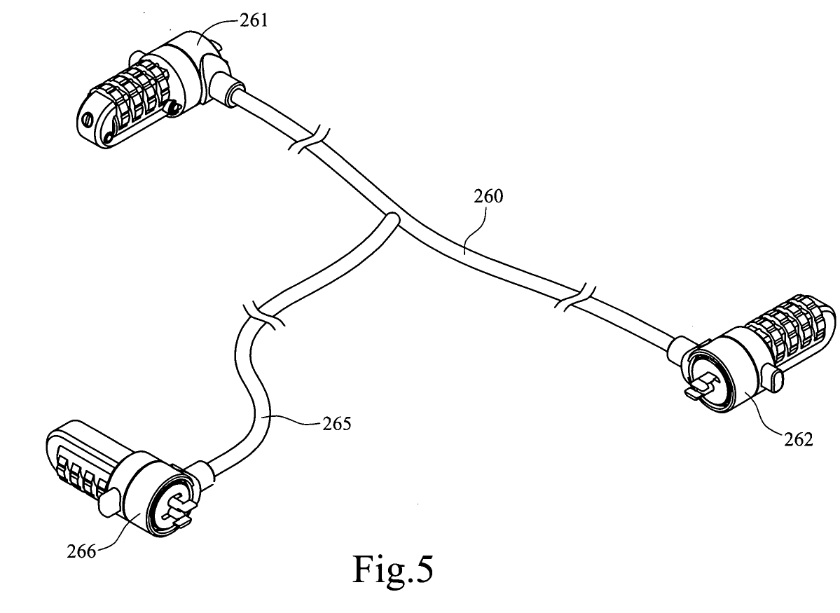

The embodiments set forth above may have many variations. FIG. 5 shows one of the examples that has two lock heads 261 and 262 fastening to two ends of a trunk wire 260. It means that the coupling section may be replaced by a lock head. It may be latched on a theft-deterrent article as the lock head 266 on the branch wire 265 does.

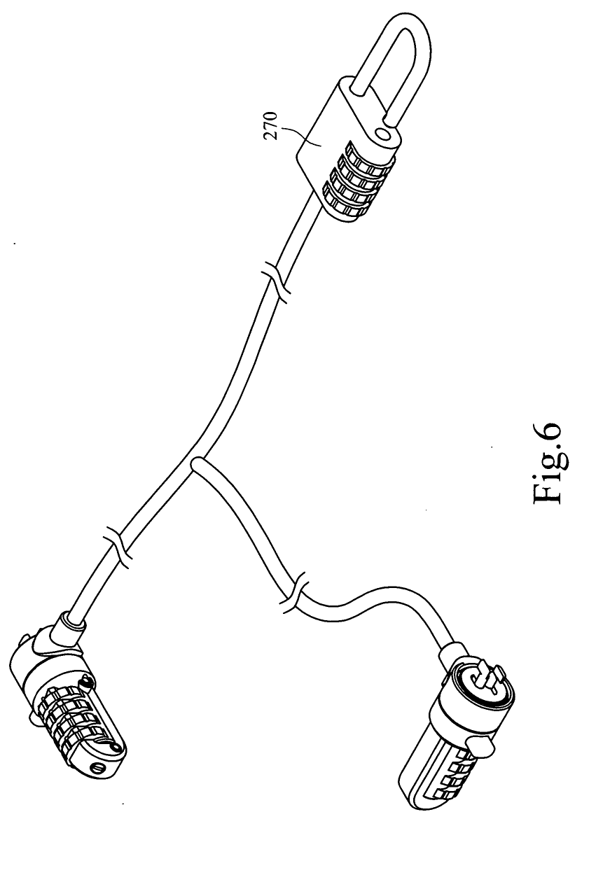

Moreover, aside from the jack lock mentioned above, the lock head may also be a padlock 270 shown in FIG. 6. It may be selected by users based on actual requirements.

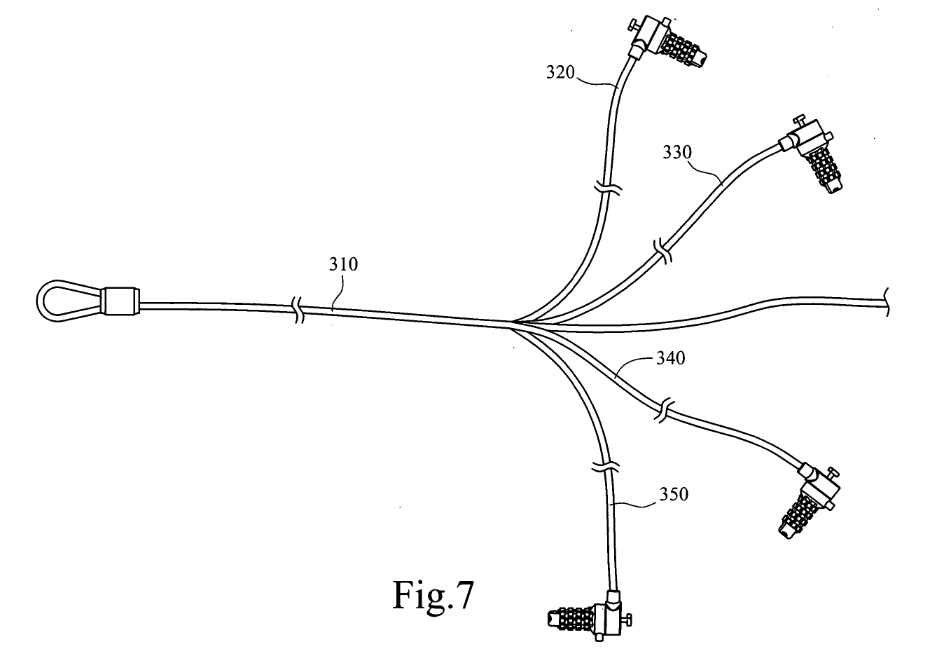

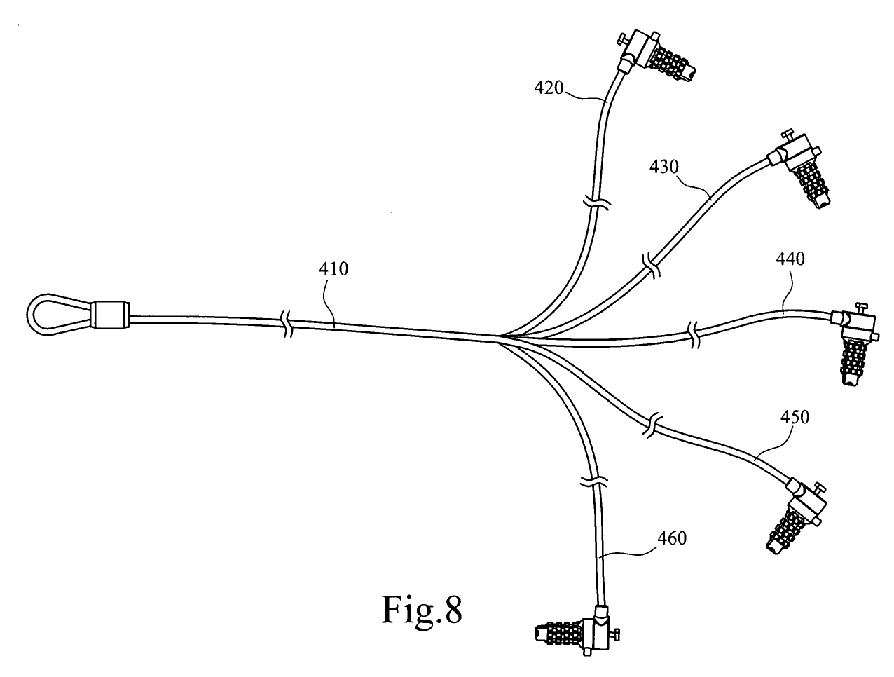

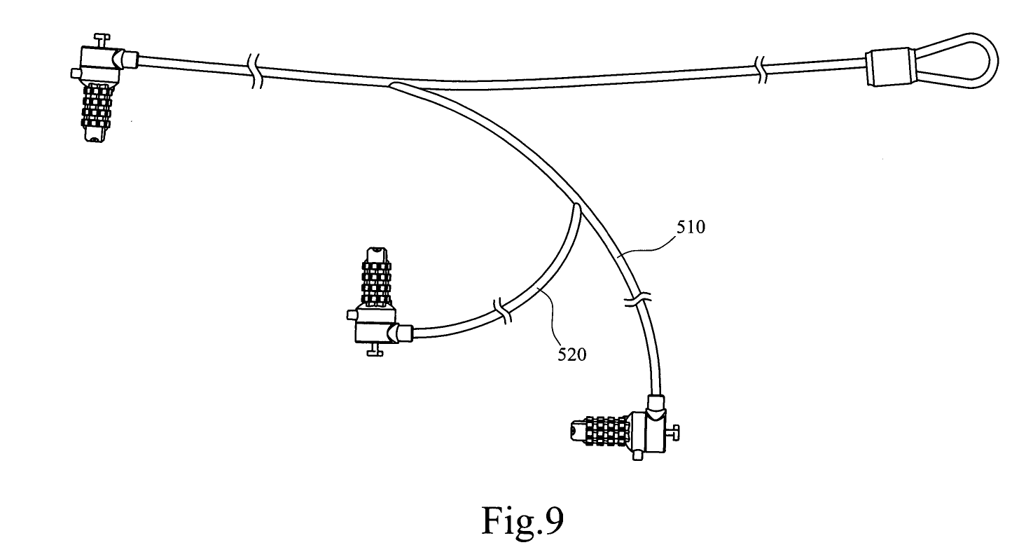

Furthermore, the locations of the branch wires connecting to the trunk wire may vary according to requirements. Referring to FIG. 7, a plurality of branch wires 320, 330, 340 and 350 may be fastened to a trunk wire 310 at a same radial location. FIG. 8 illustrates another embodiment in which a plurality of branch wires 420, 430, 440, 450 and 460 are fastened to a distal end of a trunk wire 410. FIG. 9 depicts yet another embodiment in which a branch wire 510 may further connect to a sub-branch wire 520. Thus according to the technique provided by the invention, a network type of locks may be formed to make assembly more versatile to meet display onsite requirements. And different machine types and models may be deployed close to one another for displaying to enable sales people to make introduction and comparison to customers.

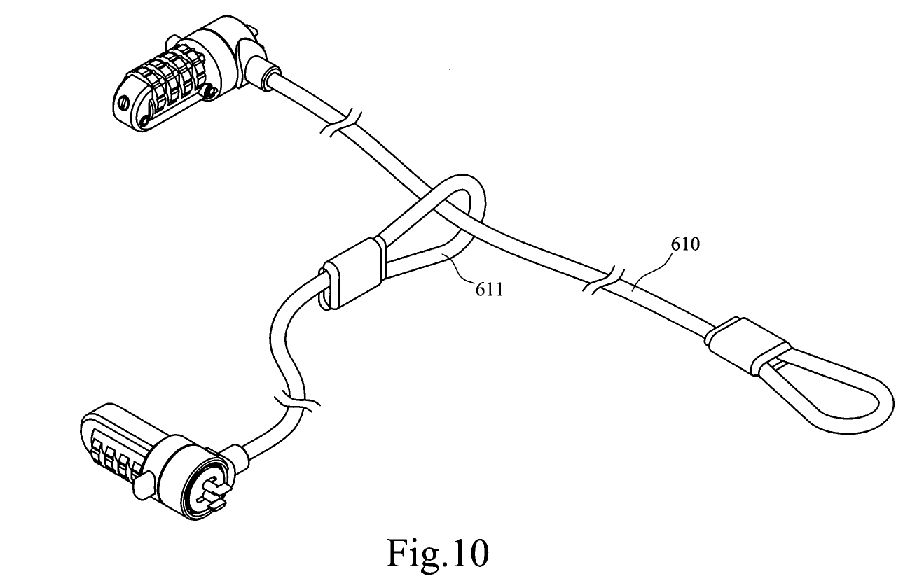

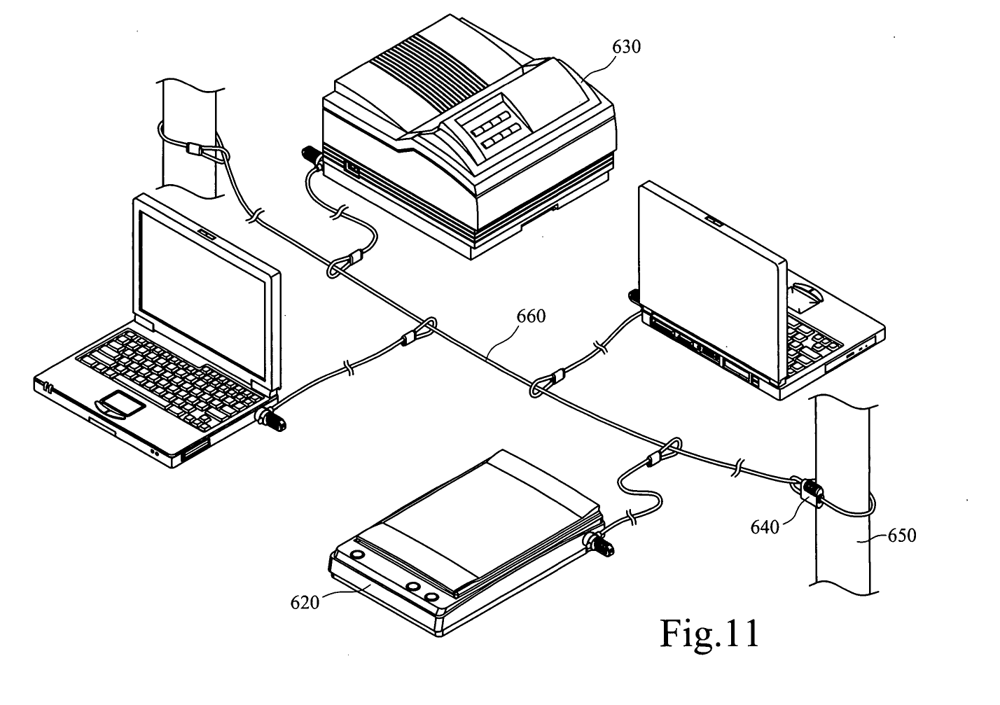

There are many ways to couple the branch wire on the trunk wire. FIG. 10 shows one of the embodiments in which an annular ring 611 is employed to movably couple on a trunk wire 610. The annular ring may also be replaced by a string knob or a coupling ring. Such a design makes the branch wire movable to adjust the article display location as shown in FIG. 11, and provides more flexibility in site selection. While the embodiments set forth above use the notebook computers as theft-deterrent articles, in practice, the present invention may be adapted to any articles that can be coupled with a lock head, such as a scanner 620 shown in the drawing, or a printer. In addition, besides the padlock to replace the jack lock to fasten to an annular article mentioned above, it may also wind around a pillar 650 and latch the padlock 640 on a trunk wire 660. Thus it is very flexible in use.

In summary, by coupling the trunk wire with branch wires, the invention may be adapted to suit different numbers and locations of anchor objects, and fastened to the anchor objects or theft-deterrent articles to achieve optimal theft-proof result.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

1-11. (canceled)

12. A branched wire lock, comprising:
a trunk wire having two coupling sections formed on its ends respectively, each of the coupling sections being capable of coupling with an anchor object; and
at least one branch wire has an annular ring to couple with the trunk wire and a lock head formed on its end.

13. The branched wire lock of claim 12, wherein one of the coupling sections is an annular ring.

14. The branched wire lock of claim 12, wherein one of the coupling sections is a lock head.

15-16. (canceled)

17. The branched wire lock of claim 12, wherein the connection wire comprises a plurality of branch wires that couple with the trunk wire.

18. (canceled)

19. The branched wire lock of claim 12, wherein the lock head is a jack lock.

20. A branched wire lock, comprising a connection wire comprises a trunk wire and at least a branch wire connecting to the truck wire, wherein the trunk wire has a coupling section at one end of the trunk wire and a first lock head at the other end of the trunk wire, and the branch wire has a second lock head at one end.

21. The branched wire lock of claim 20, wherein the connection wire is a flexible wire.

22. The branched wire lock of claim 20, wherein the connection wire is a chain.

23. The branched wire lock of claim 20, wherein the connection wire is a linkage bar.

25. The branched wire lock of claim 20, wherein the coupling section is an annular ring.

26. The branched wire lock of claim 20, wherein the coupling section is a lock head.

27. The branched wire lock of claim 20, wherein the coupling section is a padlock.

28. The branched wire lock of claim 20, wherein the first lock head and the second lock head are jack locks.

29. The branched wire lock of claim 28, wherein the jack locks are able to latch on electronic devices and computers.

30. The branched wire lock of claim 20, wherein the connection wire comprises a plurality of branch wires.

31. The branched wire lock of claim 30, wherein the connection wires are connected to the truck wire at a same radial location.

32. The branched wire lock of claim 30, wherein the branch wires are fastened to a distal end of the truck wire.

33. The branched wire lock of claim 30, wherein the branch wires connect to a sub-substrate wire which has a lock head at one end.

34. The branched wire lock of claim 30, wherein each of the branch wires further comprises an annular ring to been employed in coupling on the trunk wire.

35. The branched wire lock of claim 34, wherein each of the annular rings is a string knob or a coupling ring.

36. The branched wire lock of claim 34, wherein each of the annular rings is able to adjust the responding branch wire location.
